(19) United States
(12) Patent Application Publication
(10) Pub. No.: US 2021/0235806 A1
(43) Pub. Date: Aug. 5, 2021

(54) HELMET WITH LOW SPILLAGE AUDIO SPEAKER

(71) Applicant: Bose Corporation, Framingham, MA (US)

(72) Inventors: Chester Smith Williams, Lexington, MA (US); Andrea Y. Chan, Quincy, MA (US)

(21) Appl. No.: 17/162,102

(22) Filed: Jan. 29, 2021

Related U.S. Application Data
(60) Provisional application No. 62/968,241, filed on Jan. 31, 2020.

(51) Int. Cl. A42B 3/30; H04R 1/10

(52) U.S. Cl. CPC A42B 3/306; H04R 1/1075; H04R 1/1066; H04R 1/1083

(57) ABSTRACT

A wearable out loud (WOL) loudspeaker system is disclosed to allow un-occluded audio listening during various sporting activities. In various examples the WOL loudspeaker system may be coupled to or integrated with a helmet and configured such that the wearer may hear the out loud audio while spillage of audio to nearby bystanders is reduced.

### CROSS REFERENCE TO RELATED APPLICATIONS

This application claims a benefit under 35 USC § 119 to U.S. patent application Ser. No. 62/968,241 filed on Jan. 31, 2020, titled “HELMET WITH LOW SPILLAGE AUDIO SPEAKER” the content of which is incorporated herein in its entirety for all purposes.

### BACKGROUND

Many sporting activities involve the suggested use of helmets, such as bicycling, skating, skiing, snowboarding, etc. It may be desirable for a user of such helmets to be able to listen to audio content while also being able to hear their surroundings.

### SUMMARY

Systems and methods disclosed herein are directed to audio and video conferencing systems, methods, and applications. In particular, systems and methods disclosed are directed to peripheral systems and methods that provide control systems and methods and audio systems and methods that inter-operate with other devices that may provide video systems and methods, such as a mobile device, smart phone, tablet, etc.

According to at least one aspect, a loudspeaker system is provided that includes an enclosure configured to house at least two acoustic drivers, a first acoustic driver including a first diaphragm for producing acoustic signals, the first acoustic driver mounted in the enclosure such that a primary side of the first diaphragm faces in a first direction, and a second acoustic driver including a second diaphragm for producing acoustic signals, the second acoustic driver mounted in the enclosure such that a primary side of the second diaphragm faces in a second direction opposed to the first direction, the enclosure enclosing an acoustic volume between the first and second diaphragms such that the acoustic volume maintains a constant volume when the first and second acoustic drivers are driven out of phase with each other, and such that interior components of each of the first and second acoustic drivers are protected from the environment by the enclosure and the first and second diaphragms.

In various examples, an axis of the first acoustic driver may be parallel to but not co-axial with an axis of the second acoustic driver.

According to some examples, the enclosure may include at least one opening for each of the first acoustic driver and the second acoustic driver. In certain examples the enclosure includes at least one secondary opening configured to produce a tuning of the acoustic signals.

Some examples may include a retainer configured to retain the loudspeaker system and to couple to a helmet. The retainer may be detachably coupled to the helmet in certain examples.

Further examples include a helmet to which the loudspeaker system is coupled, wherein the loudspeaker system is positioned such that an acoustic output from the first acoustic driver is closer to a user's ear when worn and an acoustic output from the second acoustic driver is further from the user's ear. In various examples, the loudspeaker system is configured so that the acoustic output from the second acoustic driver at least partially destructively interferes with the acoustic output from the first acoustic driver at a distance. In certain examples, at least a portion of the acoustic output from the first acoustic driver is directed away from the user by reflection off a portion of the user's body. Some examples may include a retainer that mechanically couples the loudspeaker system to the helmet.

According to another aspect, sporting equipment is provided that includes a helmet configured to be worn upon and to protect a user's head when in use, an acoustic dipole, and a retainer configured to retain the acoustic dipole and mechanically couple the acoustic dipole to the helmet in an orientation such that a first acoustic output from the acoustic dipole is closer to an ear of the user and a second acoustic output is further from the ear of the user.

In some examples the retainer may be detachable from the helmet.

In various examples, the acoustic dipole includes a first acoustic driver having a first diaphragm and a second acoustic driver having a second diaphragm. A primary side of the first diaphragm may be facing in a first direction and a primary side of the second diaphragm facing in a second direction opposed to the first direction.

In certain examples the acoustic dipole may include an enclosure configured to house the first and second acoustic drivers, the enclosure enclosing an acoustic volume between the first and second diaphragms such that the acoustic volume maintains a constant volume when the first and second acoustic drivers are driven out of phase with each other, and such that interior components of each of the first and second acoustic drivers are protected from the environment by the enclosure and the first and second diaphragms.

According to various examples, the second acoustic output at least partially destructively interferes with a portion of the first acoustic output at a distance. In certain examples the first acoustic output is at least partially directed away from the user by reflection off a portion of the user's body.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a side view of an example helmet having an example retainer for a loudspeaker system;

FIG. 2 is a perspective view of an example loudspeaker system and two examples of enclosures for the loudspeaker system; and

FIG. 3 is a side view of another example helmet having an alternate example retainer for a loudspeaker system.

### DETAILED DESCRIPTION

Aspects of the present disclosure are directed to loudspeaker systems, e.g., audio transducer systems, suitable for incorporating with sporting equipment, such as helmets, that allow an audio experience for a user without occluding the user's ears. The loudspeaker systems may be positioned near a user's ear(s) without covering the user's ear(s), such that the user may readily be able to hear the loudspeaker system while also hearing surrounding sounds. Such loudspeaker systems, or modules, may be referred to herein as wearable out loud (WOL) modules. Additionally, loudspeaker transducer systems in accord with those described herein include features and physical configurations to reduce an amount of acoustic radiation emitted away from the user. In other words, the loudspeaker systems are configured to emit low amounts of acoustic radiation in the far field, such that other people nearby may not hear much audio content from the loudspeaker system despite the loudspeaker system being an out loud wearable device.

In various examples, a pair of acoustic drivers in the loudspeaker system are configured to emit acoustic radiation out-of-phase with each other, such that their individual acoustic radiation destructively interferes with each other in the far field. Positioning of the loudspeaker system, e.g., on a helmet, is such that the user hears at least one of the drivers substantially more than the other. Accordingly, at the user's ear there is substantially less destructive interference, if any, and the user is able to hear the out loud audio.

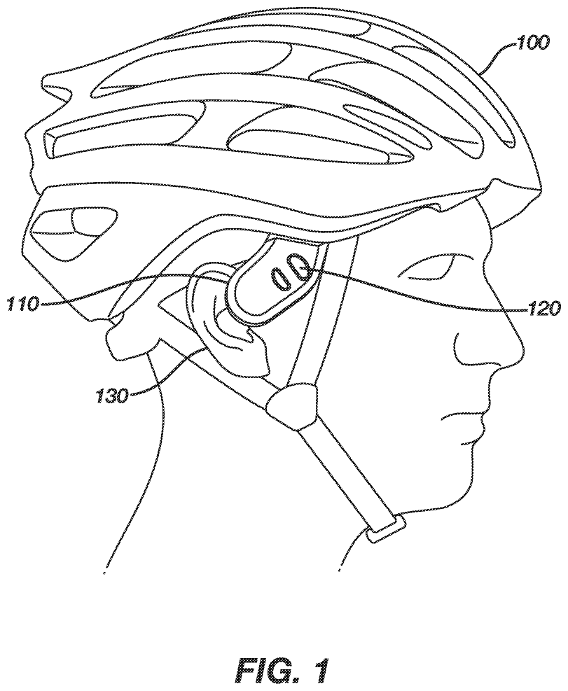

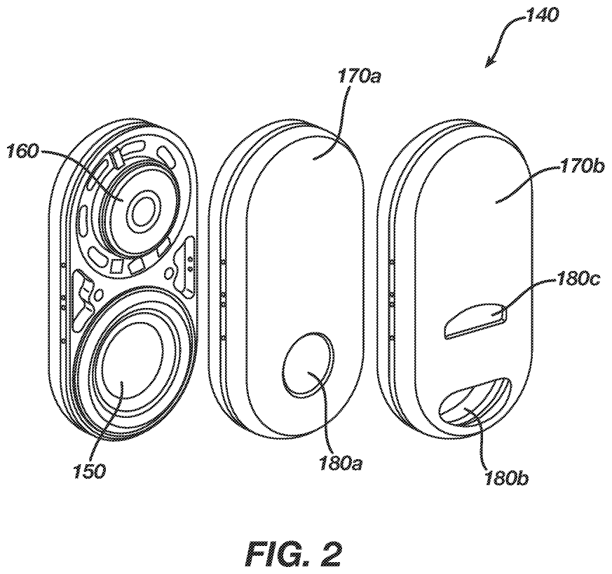

FIG. 1 illustrates an example helmet 100 to which is coupled a retainer 110 that holds a loudspeaker system 140 (shown in FIG. 2). The retainer 110 has an acoustic opening 120 to allow acoustic output from an acoustic driver to the surroundings. The retainer 110 also has another acoustic opening, e.g., facing the user and not visible in FIG. 1, to allow acoustic output closer to and/or partially directed to a user's ear 130 when the helmet 100 is worn. In various examples, the retainer 110 may be coupled or affixed to a core component of the helmet 100 while in other examples the retainer 110 may be coupled or affixed to a strap of the helmet 100. In some examples the retainer 110 may be permanently affixed while in other examples the retainer 110 may be detachable.

In various examples, the acoustic output closer to the user's ear 130 is a first acoustic output from a first acoustic driver 150 (See FIG. 2). At least some of the first acoustic output will propagate away from the user. The acoustic output emitted to the surroundings from the acoustic opening 120 is a second acoustic output produced by a second acoustic driver 160 (FIG. 2) out-of-phase with the first acoustic driver 150. Accordingly, at various locations away from the user, the second acoustic output destructively interferes with the first acoustic output such that acoustic energy in the surrounding environment is reduced.

In some examples, loudspeaker systems that produce opposing acoustic outputs, such as that of the loudspeaker system 140, such that they destructively interfere in the far field, may be referred to as an acoustic dipole, e.g., because it produces a positive acoustic pressure at one location while producing a negative acoustic pressure at another (nearby) location. The positive and negative pressures tend to acoustically cancel at a distance away from the acoustic dipole. Various examples of suitable acoustic dipoles that could substitute for the illustrated loudspeaker system 140 are disclosed in U.S. Pat. No. 9,794,677, titled HEADPHONE, granted on Oct. 17, 2017, U.S. Pat. No. 10,231,052, titled ACOUSTIC DEVICE, granted on Mar. 12, 2019, and U.S. Pat. No. 10,674,244, titled AUDIO DEVICE, granted on Jun. 2, 2020, the contents of each of which are incorporated herein by reference.

Because of this reduction in acoustic energy at a distance, the loudspeaker system 140 is said to produce low spillage, e.g., the loudspeaker system 140 “spills” only a low amount of acoustic energy to the surroundings, while allowing the user to hear an acoustic output but without occluding the user's ear 130. In some examples, the amount of spillage, or lack thereof, may be dependent upon the physical arrangement of the retainer 110 and the loudspeaker system 140. For example, the portion of the first acoustic output that propagates away from the user may depend upon the position of the retainer 110 and the loudspeaker system 140.

In various examples, the loudspeaker system 140 may be directly integrated to or removably affixed to the helmet 100 without the need for a retainer 110.

In various examples, the retainer 110, the loudspeaker 140, and/or another element of the helmet 100 may provide physical shielding that reduces wind noise in the user's ear 130, further enhancing the user's ability to hear an acoustic output when in use, e.g., such as when bicycling or otherwise moving through air.

FIG. 2 illustrates an example of the loudspeaker system 140, having the first acoustic driver 150 and the second acoustic driver 160 in an offset back-to-back arrangement. Each of the first acoustic driver 150 and the second acoustic driver 160 may be a conventional acoustic driver having a diaphragm and a central axis along which the diaphragm moves to produce acoustic output. In some examples, and as shown, the first acoustic driver 150 and the second acoustic driver 160 are offset from each other in that their axes are parallel but not co-axial.

In use, and as described above, the first acoustic driver 150 may produce a first acoustic output, a first portion of which may enter the user's ear 130 and a second portion of which may go to the surroundings, either directly or by reflection off the user's facial structure (e.g., ear, jawbone, etc.). This is because, at least in part, there is not a tight or sealed acoustic coupling between the first acoustic driver 150 and the user's ear 130. Accordingly, the loudspeaker system 140 is termed a wearable out loud system, as the user's ear 130 is not occluded by the loudspeaker system 140 and a portion of the acoustic output from the first acoustic driver 150 is emitted into the environment around the user. In various examples, the second acoustic driver 160 is driven out-of-phase with the first acoustic driver 150 such that the acoustic output from the second acoustic driver 160 destructively interferes with the portion of the acoustic output from the first acoustic driver 150 that is emitted into the environment. The loudspeaker system 140 is an example of an acoustic dipole module.

In various examples, the loudspeaker system 140 may include an enclosure. With continued reference to FIG. 2, a first example of an enclosure 170a is illustrated in which the first acoustic driver 150 and the second acoustic driver 160 are mounted. An opening 180a in the enclosure 170a is positioned in front of a respective diaphragm of each of the first acoustic driver 150 and the second acoustic driver 160 (collectively, “the acoustic drivers”). Note that in FIG. 2 the opening 180a in front of the second acoustic driver 160 is not visible as it exists on the back-side of the figure as shown. The back sides of a diaphragm of each of the acoustic drivers, along with the enclosure 170a in which the drivers are mounted, form an enclosed volume substantially sealed from the outside world.

Accordingly, an inward movement of one of the diaphragms may be accompanied by an outward movement of the other of the diaphragms. Electrical wiring to each of the acoustic drivers 150, 160 may be arranged such that the acoustic drivers are driven out-of-phase, thereby maintaining a constant interior volume. Additionally, related to the enclosed volume, the enclosure 170a and the respective diaphragms of the acoustic drivers 150, 160 provides protection to the interior components of the acoustic drivers, such as voice coils, wiring, magnetic circuit, etc. In some examples, a small relief hole may be present to prevent a buildup of a pressure differential between the interior volume and the outside environment.

Various examples may have varying enclosures 170 and openings 180. For example, also shown in FIG. 2 is an alternate enclosure 170b having various openings 180. For example, a primary opening 180b to allow acoustic output from the first acoustic driver 150, and an auxiliary opening 180c that may allow tuning the response of the first acoustic driver 150. For example, the auxiliary opening 180c may include a screen or mesh and may, in combination with the primary opening 180b, may adjust an acoustic response, e.g., relative to the enclosure 170a. A similar primary opening 180b and auxiliary opening 180c exists on the back side (not visible) with respect to the second acoustic driver 160.

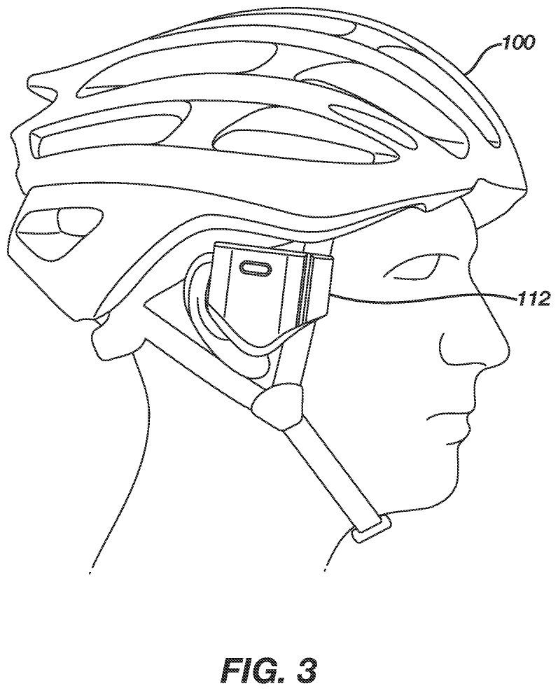

FIG. 3 illustrates another example helmet 100 having an alternate retainer 112. The retainer 112 is similar to the retainer 110 of FIG. 1 in that it accommodates and positions a loudspeaker system, e.g., the loudspeaker system 140 of FIG. 2, to allow a portion of acoustic output to be heard at the user's ear while not occluding the user's ear from hearing external sounds. The alternate retainer 112 differs from the retainer 110 in that it is removably coupled to the helmet 100, e.g., by being temporarily attached to a strap of the helmet 100. Accordingly, the user may optionally attach or remove the retainer 112 and therefore the loudspeaker system 140.

Any suitable hardware and/or software, including firmware and the like, may be configured to carry out or implement components of the aspects and examples disclosed herein, and various implementations of aspects and examples may include components and/or functionality in addition to those disclosed. Various implementations may include stored instructions for a processor, including a digital signal processor and/or other circuitry, to enable the processor, at least in part, to perform the functions described herein.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A loudspeaker system comprising:
an enclosure configured to house at least two acoustic drivers;
a first acoustic driver including a first diaphragm for producing acoustic signals, the first acoustic driver mounted in the enclosure such that a primary side of the first diaphragm faces in a first direction; and
a second acoustic driver including a second diaphragm for producing acoustic signals, the second acoustic driver mounted in the enclosure such that a primary side of the second diaphragm faces in a second direction opposed to the first direction, the enclosure enclosing an acoustic volume between the first and second diaphragms such that the acoustic volume maintains a constant volume when the first and second acoustic drivers are driven out of phase with each other, and such that interior components of each of the first and second acoustic drivers are protected from the environment by the enclosure and the first and second diaphragms.

2. The loudspeaker system of claim 1 wherein an axis of the first acoustic driver is parallel to but not co-axial with an axis of the second acoustic driver.

3. The loudspeaker system of claim 1 wherein the enclosure includes at least one opening for each of the first acoustic driver and the second acoustic driver.

4. The loudspeaker system of claim 3 wherein the enclosure includes at least one secondary opening configured to produce a tuning of the acoustic signals.

5. A retainer for the loudspeaker system of claim 1 configured to retain the loudspeaker system and to couple to a helmet.

6. The retainer of claim 5 wherein the retainer is configured to be detachably coupled to the helmet.

7. A helmet to which the loudspeaker system of claim 1 is coupled, wherein the loudspeaker system is positioned such that an acoustic output from the first acoustic driver is closer to a user's ear when worn and an acoustic output from the second acoustic driver is further from the user's ear.

8. The helmet of claim 7 wherein the loudspeaker system is configured so that the acoustic output from the second acoustic driver at least partially destructively interferes with the acoustic output from the first acoustic driver at a distance.

9. The helmet of claim 7 wherein at least a portion of the acoustic output from the first acoustic driver is directed away from the user by reflection off a portion of the user's body.

10. The helmet of claim 7 further comprising a retainer that mechanically couples the loudspeaker system to the helmet.

11. A sporting equipment comprising:
a helmet configured to be worn upon and to protect a user's head when in use;
an acoustic dipole; and
a retainer configured to retain the acoustic dipole and mechanically couple the acoustic dipole to the helmet in an orientation such that a first acoustic output from the acoustic dipole is closer to an ear of the user and a second acoustic output is further from the user's ear.

12. The sporting equipment of claim 11 wherein the retainer is detachable from the helmet.

13. The sporting equipment of claim 11 wherein the acoustic dipole comprises:
a first acoustic driver including a first diaphragm, a primary side of the first diaphragm facing in a first direction; and
a second acoustic driver including a second diaphragm, a primary side of the second diaphragm facing in a second direction opposed to the first direction.

14. The sporting equipment of claim 13 wherein the acoustic dipole further comprises an enclosure configured to house the first and second acoustic drivers, the enclosure enclosing an acoustic volume between the first and second diaphragms such that the acoustic volume maintains a constant volume when the first and second acoustic drivers are driven out of phase with each other, and such that interior components of each of the first and second acoustic drivers are protected from the environment by the enclosure and the first and second diaphragms.

15. The sporting equipment of claim 11 wherein the second acoustic output at least partially destructively interferes with a portion of the first acoustic output at a distance.

16. The sporting equipment of claim 15 wherein the first acoustic output is at least partially directed away from the user by reflection off a portion of the user's body.
